(19) United States
(12) Patent Application Publication
(10) Pub. No.: US 2008/0081272 A1
(43) Pub. Date: Apr. 3, 2008

(54) OPTICAL DISK APPARATUS AND LABEL PRINTING METHOD

(75) Inventor: Takashi SUZUKI, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Samsung Storage Technology Corporation, Kawasaki-City (JP)

(21) Appl. No.: 11/857,848

(22) Filed: Sep. 19, 2007

(30) Foreign Application Priority Data
Sep. 28, 2006 (JP) 2006-265992

(51) Int. Cl. G03C 5/00

(52) U.S. Cl. 430/30

(57) ABSTRACT

An optical disk apparatus includes an optical pickup head which radiates a laser beam on the label surface of the optical disk, thereby printing the label image information, a laser driving unit which sets a laser power of the laser beam which is radiated from the optical pickup head, a memory which stores the label image information, and a control unit which determines a label image, which is to be printed on the label surface, on the basis of the label image information, sets a trial write region within a label image region on the label surface, causes the optical pickup head to radiate the laser beam on the trial write region, sets the laser power of the laser driving unit in accordance with a reflectance obtained from reflective light of the laser beam, and prints the label image information on the label surface.

### CROSS-REFERENCE TO RELATED APPLICATIONS

This application is based upon and claims the benefit of priority from prior Japanese Patent Application No. 2006-265992, filed Sep. 28, 2006, the entire contents of which are incorporated herein by reference.

### BACKGROUND OF THE INVENTION

1. Field of the Invention

The present invention relates to an optical disk apparatus and a label printing method for effecting printing on a label surface of an optical disk by radiating a laser beam from an optical pickup head.

2. Description of the Related Art

In an optical disk apparatus, when data is optically written on a data surface of a recordable optical disk, it is necessary to execute, prior to data write, recording laser power optimization (Optimum Power Control (OPC)) for determining an optimal recording power (see, e.g. Jpn. Pat. Appln. KOKAI Publication No. 2000-99951).

A power calibration area (PCA) for executing the OPC is provided on an optical disk, such as a CD-R or CD-RW, according to the Orange Book that is a standard for CD-R/CD-RW disks. For example, in the recording laser power optimization (OPC), data write is executed on the PCA with the recording laser power being changed in the range of several levels, and the optimal recording power is determined on the basis of a result of reproduction of data from the data-written PCA (see, e.g. Jpn. Pat. Appln. KOKAI Publication No. 6-44563).

In recent years, an optical disk apparatus has been developed which can freely print a user's favorite graphic on the label surface of the optical disk, on which special coating is applied, by radiating a laser beam from an optical pickup head. In this optical disk apparatus, for example, label print schemes, such as LightScribe or Labelflash, are applied.

As regards optical disks with label surfaces on which printing can be effected, optical disks of the second generation are provided with improved special coatings on the label surfaces and have a higher print sensitivity than optical disks of the first generation which were initially developed. Thereby, the optical disks of the second generation enable printing in a shorter time on the label surfaces.

Furthermore, it is considered that, compared to the optical disks of the second generation on which printed images are expressed in a single color and gradations, optical disks of the next generation will have label surfaces on which coatings, which can add color information, are applied.

However, the conventional optical disk apparatus is not provided with means for determining an optimal recording power in the case of executing printing on the label surface of the optical disk, as in the case of recording data on the data surface. Thus, in the conventional optical disk apparatus, printing on the label surface is not always executed with an optimal power.

Moreover, the optical disk apparatus needs to have means for determining an optimal laser power, not only at the time of recording data on the data surface but also at the time of printing images on the label surface, so as to be able to deal with the printing on the label surfaces of optical disks manufactured by several makers or on the label surfaces of the next-generation optical disks to be developed in the future, as described above.

On the label surface of the optical disk, a label image can freely be printed on the entire area to which a special coating is applied. However, a dedicated area, which is used in order to determine the optimal laser power for executing printing on the label surface, which corresponds to the above-described PCA, is not secured on the label surface. Specifically, the area, which is used in order to determine the optimal laser power for executing printing on the label surface, is the entire coated area on the label surface. In this case, if a laser beam is radiated on an arbitrarily set area on the label surface of the optical disk, it is difficult to estimate a position where a trace of the radiation of the laser beam will remain on the label surface.

In other words, in the case where the laser beam is radiated on the arbitrarily set area, it is possible that the trace of the radiated laser beam may be left on a position which is other than an intended position where the image is to be printed on the label surface.

On the other hand, even in the case where a specified area on the label surface is treated as a dedicated area for determining the optimal laser power for executing printing on the label surface, this area differs from the intended area range at which the image is to be printed on the label surface, and the trace of the radiation of the laser beam may be left.

### BRIEF SUMMARY OF THE INVENTION

According to an aspect of the present invention, there is provided an optical disk apparatus which prints label image information on a label surface of an optical disk, comprising: an optical pickup head which radiates a laser beam on the label surface of the optical disk, thereby printing the label image information; a laser driving unit which sets a laser power of the laser beam which is radiated from the optical pickup head; a memory which stores the label image information; and a control unit which determines a label image, which is to be printed on the label surface, on the basis of the label image information, sets a trial write region within a label image region on the label surface, causes the optical pickup head to radiate the laser beam on the trial write region, sets the laser power of the laser driving unit in accordance with a reflectance obtained from reflective light of the laser beam, and prints the label image information on the label surface.

According to another aspect of the present invention, there is provided a label printing method for printing label image information on a label surface of an optical disk by causing an optical pickup head to radiate a laser beam on the label surface, comprising: determining a label image, which is to be printed on the label surface, on the basis of the label image information; setting a trial write region within a label image region on the label surface; causing the optical pickup head to radiate the laser beam on the trial write region; calculating a reflectance from reflective light from the trial write region; setting a laser power of the optical pickup head in accordance with reflectance; and causing the optical pickup head to radiate the laser beam of the set laser power on the label surface, and printing the label image information on the label surface.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an optical disk apparatus according to embodiments (first to third embodiments) of the present invention;

FIG. 2 is a flowchart for explaining an operation of an optical disk apparatus according to the first embodiment;

FIG. 3 is a flowchart for explaining an operation of the optical disk apparatus according to the first embodiment;

FIG. 4 is a view for explaining printing on a label surface of an optical disk 1 in the first embodiment;

FIG. 5 is a flowchart for explaining an operation of an optical disk apparatus according to the second embodiment;

FIG. 6 is a flowchart for explaining the operation of the optical disk apparatus according to the second embodiment;

FIG. 7 is a view for explaining printing on the label surface of the optical disk 1 in the second and third embodiments;

FIG. 8 is a flowchart for explaining an operation of an optical disk apparatus according to the third embodiment;

FIG. 9 is a flowchart for explaining the operation of the optical disk apparatus according to the third embodiment; and

FIG. 10 is a flowchart for explaining the operation of the optical disk apparatus according to the third embodiment.

### DETAILED DESCRIPTION OF THE INVENTION

Embodiments of the present invention will now be described with reference to the accompanying drawings.

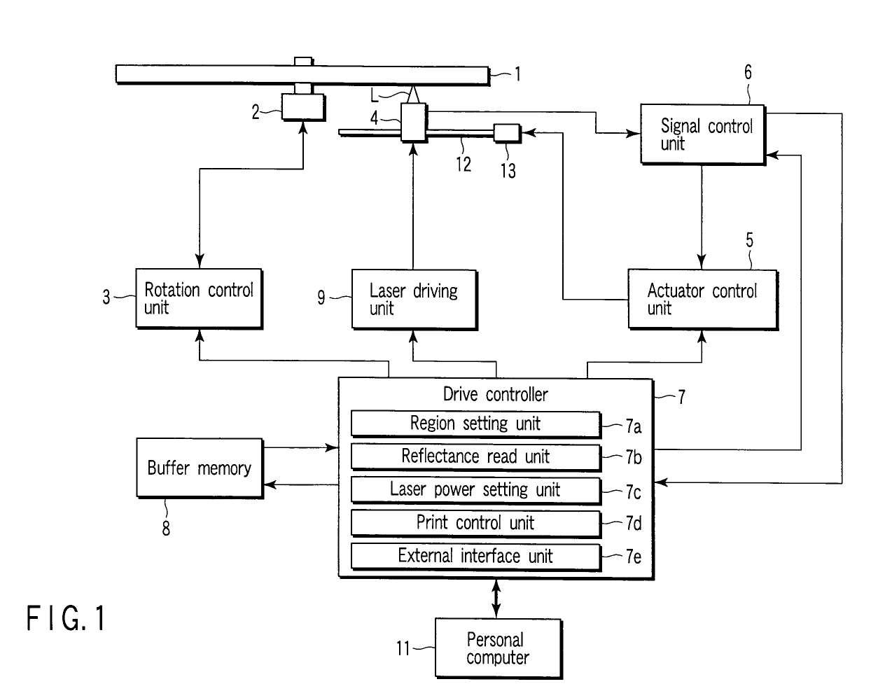

FIG. 1 is a block diagram showing the structure of an optical disk apparatus according to embodiments (first to third embodiments) of the invention.

The optical disk apparatus according to the embodiments has a function of printing a label image on a label surface of an optical disk 1 by using a laser beam which is radiated from an optical pickup head 4 onto the label surface. A special coating material is applied to the label surface of the optical disk 1 that is used in the embodiments. A chemical reaction takes place in the coating material on the label surface due to heat that is produced by the radiation of the laser beam. Thereby, a label image is drawn on the label surface. In addition, a region, on which information relating to media is recorded, is provided on an innermost peripheral part of the label surface of the optical disk 1. This region stores, for example, information indicating that printing can be effected on the optical disk 1 by a laser beam, position information indicative of a reference position in a circumferential direction which is used when printing is effected on the label surface, and information about the manufacturer of the optical disk (media ID).

As shown in FIG. 1, the optical disk apparatus includes a motor 2 which rotates the optical disk 1 that is an information recording medium on which data is recorded, and a rotation control unit 3 which controls the rotation speed of the motor 2.

In addition, the optical disk apparatus includes the optical pickup head 4 which radiates a laser beam L of a semiconductor laser to the optical disk 1; a lead screw 12 which supports the optical pickup head 4 such that the optical pickup head 4 is movable in a radial direction of the optical disk 1; a stepping motor 13 which rotates the lead screw 12; an actuator control unit 5 which controls the rotation of the stepping motor 13; and a signal control unit 6 which detects a signal from the optical pickup head 4. When the stepping motor 13 is driven, the optical pickup head 4 is moved along the lead screw 12 to a position where the optical pickup head 4 faces the optical disk 1.

The optical pickup head 4 radiates a laser beam to the label surface of the optical disk 1 at the time of printing a label image on the label surface of the optical disk 1, as well as radiating a laser beam to the data surface of the optical disk 1 at the time of recording data and reproducing data. In addition, the optical pickup head 4 radiates a laser beam to a preset region on the label surface prior to printing a label image on the label surface, thereby to determine an optimal laser power for printing the label image on the label surface. Furthermore, the optical pickup head 4 outputs to the signal control unit 6 a signal corresponding to reflective light from the optical disk 1 at a time when a laser beam is radiated on the optical disk 1. In the meantime, the “label image” to be printed on the label surface, in this context, refers to an image, text, graphics, etc.

The optical disk apparatus further includes a drive controller 7 which executes an overall control of the optical disk apparatus. The drive controller 7 includes a CPU and memories, such as a ROM and a RAM, which are used when the CPU executes various processes. The CPU executes various programs stored in the memories, thereby realizing various functions. The drive controller 7 executes, as well as data read/write from/to a buffer memory 8, various processes for executing printing on the label surface of the optical disk 1.

The drive controller 7 includes a region setting unit 7a, a reflectance read unit 7b, a laser power setting unit 7c, a print control unit 7d and an external interface unit 7e. These units may be composed of hardware and/or software.

The region setting unit 7a sets on the label surface a region which is used in order to determine a laser power at a time of effecting printing on the label surface, in accordance with a label image to be printed on the label surface of the optical disk 1. Prior to printing the label image, trial write is executed on this region, and a reflectance after the trial write is measured. In the description below, the region that is set by the region setting unit 7a is referred to as “measurement region”.

The reflectance read unit 7b reads a reflectance of the laser beam that is radiated on the measurement region set by the region setting unit 7a. The reflectance read unit 7b first radiates a laser beam on the measurement region set by the region setting unit 7a and then radiates a laser beam, which has a lower laser power than the first radiated laser beam, to the measurement region, thereby detecting the reflectance on the basis of a signal detected in accordance with the reflective light.

The laser power setting unit 7c sets a laser power at a time of printing a label image on the label surface, in accordance with the reflectance read by the reflectance read unit 7b.

The print control unit 7d causes the optical pickup head 4 to radiate a laser beam with the laser power that is set by the laser power setting unit 7c, thus executing a control for printing the label image on the label surface of the optical disk 1.

The external interface unit 7e is an interface with a personal computer 11 which is an upper-level apparatus that controls the optical disk apparatus. The external interface unit 7e executes transmission/reception of data and commands to/from the personal computer 11.

The optical disk apparatus further includes a buffer memory 8 which temporarily stores data which is transferred from the personal computer 11, and a laser driving unit 9 which controls the radiation of the laser beam by the optical pickup head 4 in accordance with an instruction from the drive controller 7.

### First Embodiment

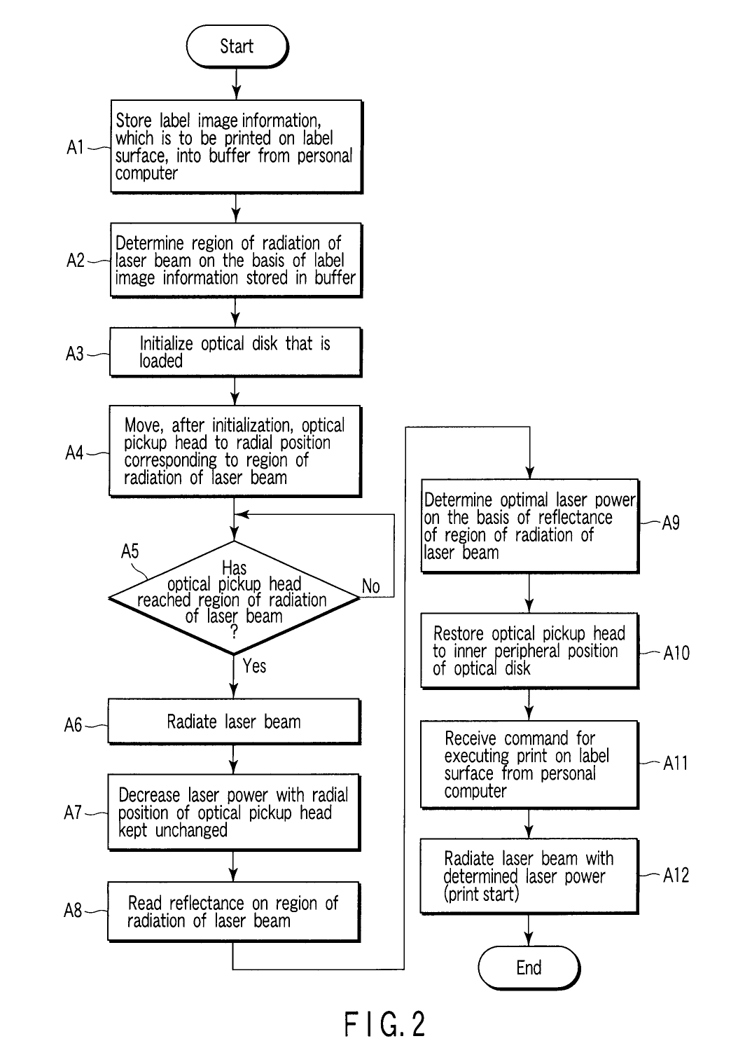

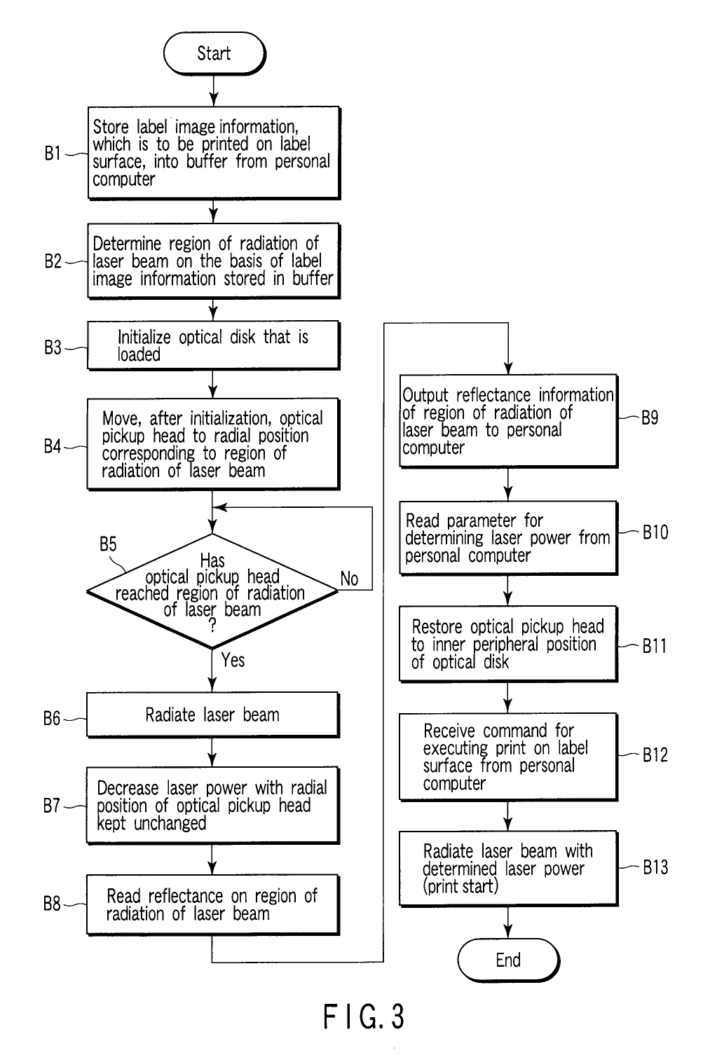

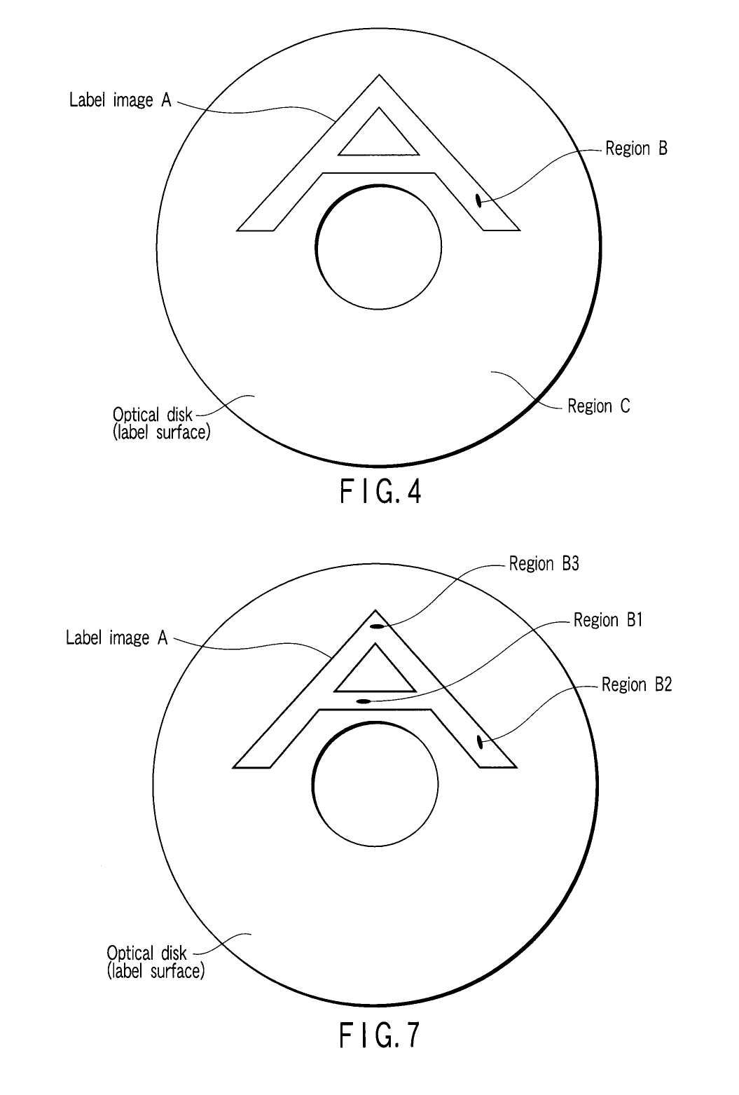

Next, the operation of an optical disk apparatus according to a first embodiment of the invention is described with reference to flowcharts of FIG. 2 and FIG. 3. FIG. 4 is a view for explaining printing on the label surface of the optical disk 1 in the first embodiment.

Referring to the flowchart of FIG. 2, a description is given of the case in which a parameter for controlling the laser power of the laser beam is stored in the drive controller 7. Referring to the flowchart of FIG. 3, a description is given later of the case in which the parameter is stored in the personal computer 11.

To begin with, the drive controller 7 receives information of a label image (“label image information”), which is to be printed on the label surface of the optical disk 1, from the personal computer 11 via the external interface unit 7e, and the drive controller 7 temporarily stores the received label image information in the buffer memory 8 (step A1).

On the basis of the label image information stored in the buffer memory 8, the region setting unit 7a of the drive controller 7 sets on the label surface a measurement region which is used in order to determine an optimal laser power at a time of printing a label image on the label surface (step A2). Specifically, the region setting unit 7a determines a range of the label image to be printed on the label surface of the optical disk 1, on the basis of the label image information stored in the buffer memory 8, and sets the measurement region within the range of the determined label image. Based on the label image information, the region setting unit 7a detects position information in the radial direction and circumferential direction of the label image to be printed on the label surface. Further, based on the detected position information, the region setting unit 7a determines the measurement region so that the measurement region may be included within the range of the label image.

FIG. 4 shows an example of the measurement region that is set on the label surface in the first embodiment. In FIG. 4, a label image A indicates the range of an image to be printed on the basis of the label image information stored in the buffer memory 8. A measurement region B, which is used in order to determine the laser power, is set to be included in the range of the label image A when the label image A is printed.

The size of the measurement region is not limited if the reflectance on the region, on which trial write is executed in order to determine the laser power at the time of printing the label image, can be measured after the trial write is executed. The measurement region may be set at a predetermined size or may be varied in accordance with the pattern of the label image to be printed. Besides, the shape of the measurement region may be altered in accordance with the label image.

Besides, the position of the measurement region may be anywhere within the range of the label image. However, the position of the measurement region may be set, for example, within a predetermined range in the radial direction of the optical disk 1.

In the next operation step, if the optical disk 1 is set such that the label surface of the optical disk 1 faces downward (i.e. faces the optical pickup head 4), the optical disk apparatus executes an initializing process for the optical disk 1 (step A3). The drive controller 7 causes the rotation control unit 3 to rotate the motor 2, and causes the laser driving unit 9 to drive the optical pickup head 4 to radiate the laser beam, thus executing the initializing process. In the initializing process, various information is read from the region which is provided on the innermost peripheral part of the label surface and on which the information relating to the media is recorded.

If the information, which indicates that the optical disk is an optical disk on which printing can be effected by the laser beam, is read, the drive controller 7 starts the following process.

Following the completion of the initializing process, the drive controller 7 causes the actuator control unit 5 to move the optical pickup head 4 to a radial position corresponding to the measurement region set by the region setting unit 7a (step A4). The positioning in the case of moving the optical pickup head 4 in the radial direction of the optical disk 1 is carried out by driving the stepping motor 13 by the actuator control unit 5 in accordance with the position of the optical pickup head 4 which is detected by a sensor (not shown) for detecting the position of the optical pickup head 4. Alternatively, the position of the optical pickup head 4 can be detected on the basis of the amount of rotation of the stepping motor 13, with the initial position of the optical pickup head 4 (e.g. the innermost peripheral position) being used as a reference position.

If the optical pickup head 4 reaches a track position corresponding to the measurement region (Yes in step A5) and the optical disk 1 rotates and comes to a circumferential position corresponding to the measurement region, the drive controller 7 causes the laser driving unit 9 to drive the optical pickup head 4 to radiate the laser beam onto the measurement region of the optical disk 1 (step A6). In this case, the laser beam is radiated with such a laser power that trial write can be executed on the measurement region. The drive controller 7 detects the position of the optical disk 1, which is opposed to the optical pickup head 4, on the basis of the position information which is read out in the initializing process and is used as the reference position in the circumferential direction.

The drive controller 7 controls the laser driving unit 9 so as to cause the optical pickup head 4 to radiate a laser beam, and then to decrease the laser power of the laser beam, which is radiated from the optical pickup head 4, with the radial position of the optical pickup head 4 being kept unchanged (step A7). Specifically, the laser beam is radiated from the optical pickup head 4 by setting the laser power for reading the reflectance from the measurement region on which trial write has been executed.

The optical pickup head 4 receives reflective light of the laser beam which has been radiated on the measurement region, and outputs a signal corresponding to the reflective light to the signal control unit 6. The signal control unit 6 executes a predetermined process on the signal that is input from the optical pickup head 4, and outputs the processed signal to the drive controller 7.

The reflectance read unit 7b of the drive controller 7 reads the reflectance on the measurement region on the basis of the signal that is input from the signal control unit 6 (step A8). Based on the reflectance that is read by the reflectance read unit 7b, the laser power setting unit 7c determines an optimal laser power for the printing on the label surface, and sets a parameter for causing the optical pickup head 4 to radiate the laser beam of the optimal laser power, and stores the parameter in the drive controller 7 (step A9).

An example of the laser power determination process in the laser power setting unit 7c is described.

Coefficient data, which corresponds to the characteristics of the special coating on the label surface, is prestored in the drive controller 7 in association with individual manufacturer information (media ID) which is recorded on the optical disk 1 (i.e. in association with each type of product of each manufacturer). In the initializing process executed in step A3, the manufacturer information (media ID) recorded on the optical disk 1 is read, and the coefficient data that agrees with the media ID is discriminated. The laser power setting unit 7c executes a multiplication arithmetic operation of the reflectance that is read from the measurement region and the coefficient data agreeing with the media ID. Based on the result of the arithmetic operation, the laser power setting unit 7c determines the optimal laser power for the label surface of the optical disk 1 that is currently the object of printing.

The reflectance can also be read in the following manner. For example, while the position of radiation of the laser beam within the measurement region is being varied, the laser beam is radiated and the process of reading the reflectance is repeated a plural number of times. By averaging a plurality of reflectance values that are read, the reflectance relating to the measurement region is set. In the case where the laser beam is repeatedly radiated on the measurement region, the laser power may be varied each time the laser beam is radiated.

After the above-described process has been carried out, the drive controller 7 causes the actuator control unit 5 to move the optical pickup head 4 to the innermost peripheral position on the optical disk 1 in preparation for the start of print on the label surface (step A10).

If the execution of print on the label surface of the optical disk 1 is instructed by the user, the personal computer 11 outputs a print start command to the optical disk apparatus. If the drive controller 7 receives the print start command via the external interface unit 7e (step A11), the drive controller 7 causes the print control unit 7d to start the print process on the label surface of the optical disk 1 (step A12). If the print process starts, the print control unit 7d executes printing by the laser beam, which is radiated from the optical pickup head 4, in accordance with the position information (i.e. positions in the radial direction and circumferential direction) which is indicative of the position where the label image is to be printed on the label surface and which is based on the label image information stored in the buffer memory 8. Specifically, the print control unit 7d drives the actuator control unit 5 to move the optical pickup head 4 in the radial direction from the inner peripheral side of the optical disk 1 within the range of the printing of the label image. While the optical pickup head 4 is being moved, the print control unit 7d drives the laser driving unit 9 to cause the optical pickup head 4 to radiate the laser beam at a timing when the laser beam from the optical pickup head 4 is radiated on the print range of the label image on the optical disk 1 that is rotated by the motor 2. At this time, the print control unit 7d controls the laser driving unit 9 to cause the optical pickup head 4 to radiate the laser beam with the laser power corresponding to the parameter that is set by the laser power setting unit 7c.

The measurement region is set to be included within the range of the label image in accordance with the position information relating to the printing of the label image on the label surface. Accordingly, the measurement region is overwritten by the label image by printing the label image in accordance with the position information. Thus, the trace of the trial write on the measurement region is erased by the label image.

Next, referring to the flowchart of FIG. 3, a description is given of the case in which the parameter for determining the optimal laser power for the printing on the label surface is stored in the personal computer 11.

Assume now that a writing application program for controlling the process of executing the printing on the label surface in the optical disk apparatus is installed in the personal computer 11. In the writing application program, a parameter for controlling the laser power of the laser beam, which is radiated from the optical pickup head 4 of the optical disk 1 is preset in a setup file.

The process of steps B1 to B8 in the flowchart of FIG. 3 is executed in the same manner as the process of steps A1 to A8 in the flowchart of FIG. 2, so a description thereof is omitted here.

If the reflectance on the measurement region is read by the reflectance read unit 7b, the laser power setting unit 7c outputs reflectance information indicative of the reflectance to the personal computer 11 via the external interface unit 7e (step B9).

The personal computer 11 operates according to the writing application program. The personal computer 11 reads out the parameter corresponding to the reflectance information, which is input from the optical disk apparatus, from the setup file, and outputs the parameter corresponding to the reflectance information to the optical disk apparatus (step B10).

The laser power setting unit 7c reads out the parameter that is output from the personal computer 11, and the read-out parameter is stored in the drive controller 7.

Subsequently, the same process as in steps A10 to A12 in the flowchart of FIG. 2 is executed (steps B11 to B13).

In the above description, the reflectance information is output to the personal computer 11, and the parameter corresponding to the reflectance information is acquired. Alternatively, the manufacturer information (media ID) which is read from the optical disk 1, together with the reflectance information, may be output to the personal computer 11.

It is assumed that the coefficient data corresponding to the characteristics of the special coating on the label surface is preset in the setup file of the personal computer 11 in association with each manufacturer information (media ID). The personal computer 11 reads out from the setup file the coefficient data corresponding to the media ID that is input from the optical disk apparatus, and multiplies the coefficient data with the reflectance. Based on the arithmetic result, the personal computer 11 determines the optimal laser power for the label surface of the optical disk 1 which is the object of the print, and sets the parameter for causing the optical pickup head 4 to radiate the laser beam of the optimal laser power, and outputs the parameter to the optical disk apparatus.

As has been described above, in the optical disk apparatus according to the first embodiment, it is possible to set the measurement region for use in determining the laser power at the time of printing the label image, in accordance with the label image to be printed on the label surface of the optical disk 1. Even if trial write is executed on the measurement region, the label image can be printed so as to overwrite the measurement region. Accordingly, the trace of the trial write for determining the laser power is not left on the label surface. Thereby, the label image can be printed by the optimal laser power without leaving the trace of the radiation of the laser beam at a position different from the position of the label image.

The laser power at the time of printing is determined on the basis of the trial write on the label surface of the optical disk 1. Thereby, the printing can be executed with the laser beam having the optimal laser power, even if there are non-uniformity in devices mounted on individual optical disk apparatuses, a difference in environment in which the optical disk apparatus is operated, non-uniformity or variations in characteristics of the coatings on the label surfaces of optical disks, and warp on the optical disk 1.

### Second Embodiment

In the first embodiment, one measurement region is set on the label surface of the optical disk 1, and the optimal laser power at the time of printing the label image on the label surface is determined by using the measurement region. In a second embodiment of the invention, a plurality of measurement regions are set at different positions on the label surface of the optical disk 1, and the optimal laser power is determined by using the plural measurement regions.

By setting the plural measurement regions and determining the optimal laser power, it becomes possible to reduce an influence in a case where the reflectance varies from position to position on the label surface. For example, even in the case where the reflectance on one measurement region set on the label surface differs from that on another region due to non-uniformity in the coating on the label surface, adhesion of stains or warp of the optical disk 1, the reflectance can be read on the basis of the plural measurement regions and the influence of the measurement region, the reflectance of which differs from the reflection on another region, can be reduced.

The structure of the optical disk apparatus in the second embodiment is basically the same as that in the first embodiment, so a description of the circuit structure of the optical disk apparatus in the second embodiment is omitted here.

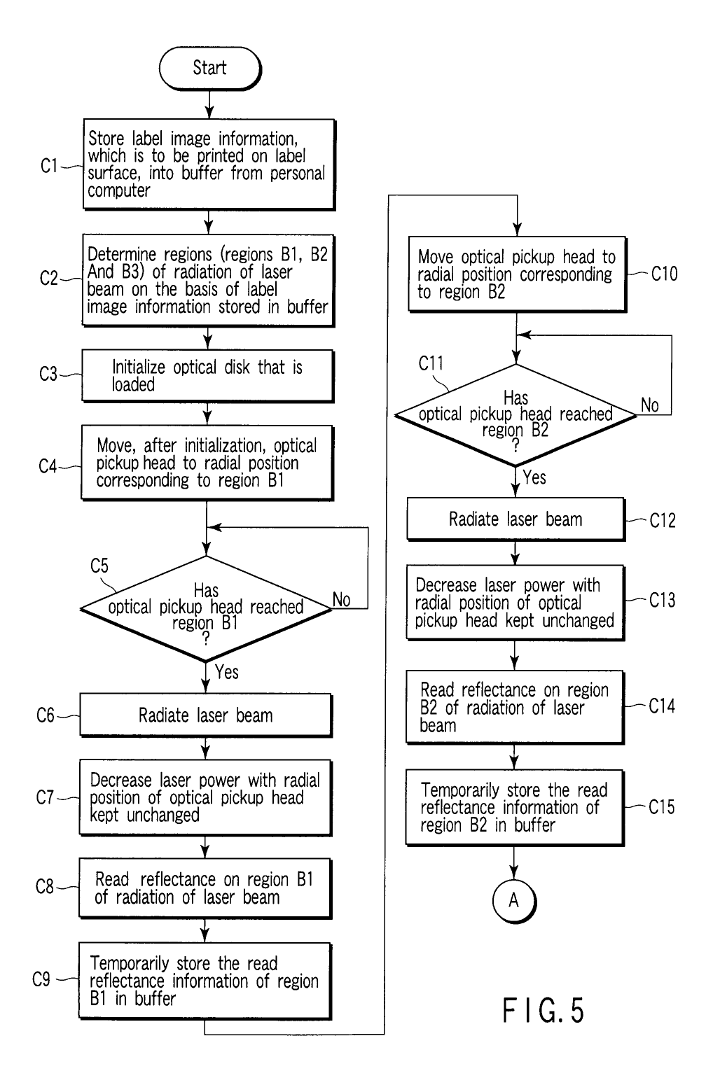

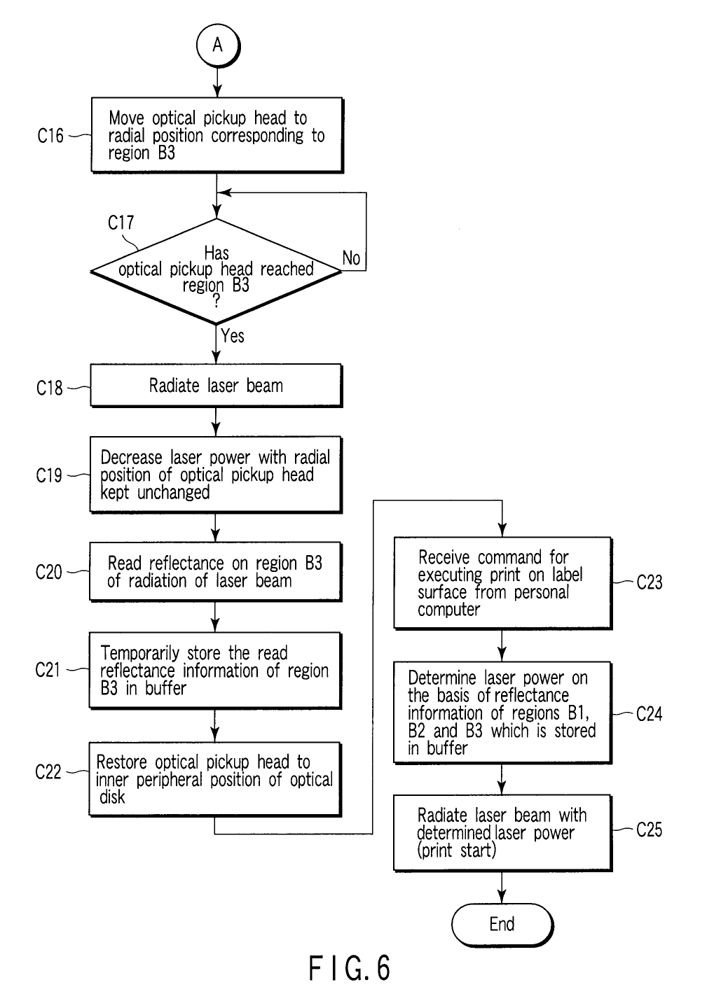

Next, the operation of the optical disk apparatus according to the second embodiment of the invention is described with reference to flowcharts of FIG. 5 and FIG. 6. FIG. 7 is a view for explaining printing on the label surface of the optical disk 1 in the second embodiment.

To begin with, the drive controller 7 receives information of a label image (“label image information”), which is to be printed on the label surface of the optical disk 1, from the personal computer 11 via the external interface unit 7e, and the drive controller 7 temporarily stores the received label image information in the buffer memory 8 (step C1).

On the basis of the label image information stored in the buffer memory 8, the region setting unit 7a of the drive controller 7 sets a plurality of measurement regions at a plurality of positions on the label surface, the measurement regions being used in order to determine an optimal laser power at a time of printing a label image on the label surface (step C2).

Specifically, the region setting unit 7a determines a range of the label image to be printed on the label surface of the optical disk 1, on the basis of the label image information stored in the buffer memory 8, and sets the plural measurement regions within the range of the determined label image. Based on the label image information, the region setting unit 7a detects position information in the radial direction and circumferential direction of the label image to be printed on the label surface. Further, based on the detected position information, the region setting unit 7a determines the plural measurement regions according to predetermined conditions so that the plural measurement regions may be included within the range of the label image.

FIG. 7 shows an example of the measurement region that is set on the label surface in the second embodiment. In FIG. 7, a label image A indicates the range of an image to be printed on the basis of the label image information stored in the buffer memory 8. In the example shown in FIG. 7, three measurement regions B1, B2 and B3, for instance, are set as measurement regions which are used in order to determine the laser power. The three measurement regions B1, B2 and B3 are set to be included in the range of the label image A when the label image A is printed. In the example shown in FIG. 7, the measurement region B1, measurement region B2 and measurement region B3 are successively arranged in the named order from the innermost peripheral side of the optical disk 1.

Like the first embodiment, the size of the measurement region is not limited if the reflectance on the region, on which trial write is executed in order to determine the laser power at the time of printing the label image, can be measured after the trial write is executed. Each measurement region may be set at a predetermined size or may be varied in accordance with the pattern of the label image to be printed. The shape of each measurement region may be altered according to the label image. The plural measurement regions may be equal in size and shape or may be different in accordance with the label image to be printed.

In the next operation step, if the optical disk 1 is set, the optical disk apparatus executes an initializing process for the optical disk 1 (step C3). The drive controller 7 causes the rotation control unit 3 to rotate the motor 2, and causes the laser driving unit 9 to drive the optical pickup head 4 to radiate the laser beam, thus executing the initializing process.

Following the completion of the initializing process, the drive controller 7 causes the actuator control unit 5 to move the optical pickup head 4 to a radial position corresponding to the measurement region B1 set by the region setting unit 7a (step C4). If the optical pickup head 4 reaches a position corresponding to the measurement region B1 (Yes in step C5) and the optical disk 1 rotates to a circumferential position corresponding to the measurement region B1, the drive controller 7 causes the laser driving unit 9 to drive the optical pickup head 4 to radiate the laser beam (step C6). In this case, the laser beam is radiated with such a laser power that trial write can be executed on the measurement region B1.

The drive controller 7 controls the laser driving unit 9 so as to cause the optical pickup head 4 to radiate a laser beam, and then to decrease the laser power of the laser beam, which is radiated from the optical pickup head 4, with the radial position of the optical pickup head 4 being kept unchanged (step C7). Specifically, the laser beam is radiated from the optical pickup head 4 by setting the laser power for reading the reflectance from the measurement region B1 on which trial write has been executed.

The optical pickup head 4 receives reflective light of the laser beam which has been radiated on the measurement region B1, and outputs a signal corresponding to the reflective light to the signal control unit 6. The signal control unit 6 executes a predetermined process on the signal that is input from the optical pickup head 4, and outputs the processed signal to the drive controller 7.

The reflectance read unit 7b of the drive controller 7 reads the reflectance on the measurement region B1 on the basis of the signal that is input from the signal control unit 6 (step C8). The reflectance read unit 7b temporarily stores the reflectance information indicative of the reflectance on the measurement region B1 in the buffer memory 8 (step C9).

Subsequently, the drive controller 7 causes the actuator control unit 5 to move the optical pickup head 4 to a radial position corresponding to the next set measurement region B2 (step C10). If the optical pickup head 4 reaches a position corresponding to the measurement region B2 (Yes in step C11) and the optical disk 1 rotates to a circumferential position corresponding to the measurement region B2, the drive controller 7 causes the laser driving unit 9 to drive the optical pickup head 4 to radiate the laser beam (step C12). In this case, the laser beam is radiated with such a laser power that trial write can be executed on the measurement region B2.

The drive controller 7 controls the laser driving unit 9 so as to cause the optical pickup head 4 to radiate a laser beam, and then to decrease the laser power of the laser beam, which is radiated from the optical pickup head 4, with the radial position of the optical pickup head 4 being kept unchanged (step C13). Specifically, the laser beam is radiated from the optical pickup head 4 by setting the laser power for reading the reflectance from the measurement region B2 on which trial write has been executed.

The optical pickup head 4 receives reflective light of the laser beam which has been radiated on the measurement region B2, and outputs a signal corresponding to the reflective light to the signal control unit 6. The signal control unit 6 executes a predetermined process on the signal that is input from the optical pickup head 4, and outputs the processed signal to the drive controller 7.

The reflectance read unit 7b of the drive controller 7 reads the reflectance on the measurement region B2 on the basis of the signal that is input from the signal control unit 6 (step C14). The reflectance read unit 7b temporarily stores the reflectance information indicative of the reflectance on the measurement region B2 in the buffer memory 8 (step C15).

After storing the reflectance information relating to the measurement region B2 in the buffer memory 8, the drive controller 7 acquires the reflectance information relating to the measurement region B3 in the same manner as in the case of the measurement region B1 and measurement region B2, and temporarily stores the reflectance information of the measurement region B3 in the buffer memory 8 (steps C16 to C21). Since steps C16 to C21 are the same as steps C6 to C9 or steps C10 to C15, a description thereof is omitted here.

After storing the reflectance information relating to the measurement regions B1, B2 and B3 in the buffer memory 8, the drive controller 7 causes the actuator control unit 5 to move the optical pickup head 4 to the innermost peripheral position on the optical disk 1 in preparation for the start of print on the label surface (step C22).

If the execution of print on the label surface of the optical disk 1 is instructed from the personal computer 11, a print start command is output to the optical disk apparatus. The laser power setting unit 7c receives the print start command via the external interface unit 7e (step C23). Based on the reflectance information relating to the measurement regions B1, B2 and B3, which is stored in the buffer memory 8, the laser power setting unit 7c determines an optimal laser power for the printing on the label surface, and sets a parameter for causing the optical pickup head 4 to radiate the laser beam of the optimal laser power (step C24).

An example of the laser power determination process in the laser power setting unit 7c is described.

As in the first embodiment, coefficient data, which corresponds to the characteristics of the special coating on the label surface, is prestored in the drive controller 7 in association with individual manufacturer information (media ID) which is recorded on the optical disk 1. In the initializing process executed in step C3, the manufacturer information (media ID) recorded on the optical disk 1 is read, and the coefficient data that agrees with the media ID is discriminated. The laser power setting unit 7c finds a mean value of the reflectance information relating to the plural measurement regions B1, B2 and B3, and executes a multiplication arithmetic operation of the mean value and the coefficient data. Based on the result of the arithmetic operation, the laser power setting unit 7c determines the optimal laser power for the label surface of the optical disk 1 that is currently the object of printing. The laser power setting unit 7c sets the parameter for causing the optical pickup head 4 to radiate the laser beam of the optimal laser power, and the parameter is stored in the drive controller 7.

Subsequently, the drive controller 7 causes the print control unit 7d to start the print process on the label surface of the optical disk 1 (step C25). The print control unit 7d drives the laser driving unit 9 to cause the optical pickup head 4 to radiate the laser beam with the laser power corresponding to the parameter that is set by the laser power setting unit 7c. Thereby, the printing is executed with the optimal laser power that is determined by using the plural measurement regions B1, B2 and B3. The printing process is executed in the same manner as in the above-described first embodiment, so a detailed description thereof is omitted here.

The plural measurement regions B1, B2 and B3, which are set on the label surface, are set to be included within the range of the label image in accordance with the position information relating to the printing of the label image on the label surface. Accordingly, all the measurement regions B1, B2 and B3 are overwritten by printing the label image in accordance with the position information. Thus, the traces of the trial write on the measurement regions are erased by the label image.

Like the first embodiment, even in the case where the parameter for controlling the optimal laser power is set in the personal computer 11 (the setup file in the writing application program), it is possible to determine the optimal laser power and the parameter on the basis of the reflectances that are read from the plural measurement regions B1, B2 and B3. A detailed description of this technique is omitted.

As has been described above, in the optical disk apparatus of the second embodiment, the laser power at the time of printing the label image is determined by using the plural measurement regions set on the label surface. Therefore, in addition to the advantageous effect in the first embodiment, the optical disk apparatus of the second embodiment has the advantage that even in the case where the reflectance varies from position to position on the label surface, the adverse effect due to this variation can be reduced and the optimal laser power can be determined.

### Third Embodiment

In the second embodiment, the laser power of the laser beam, which is radiated at the time of printing the label image, is determined on the basis of the plural measurement regions set on the label surface. In a third embodiment of the invention, a plurality of laser powers are set on the basis of a plurality of measurement regions set on the label surface, and a label image is printed by radiating laser beams of different laser powers on plural regions on the label surface.

For example, even in the case where optimal laser powers for a plurality of regions which are divided in the radial direction are different due to warp of the optical disk 1 or non-uniformity in the coating, a label image is printed by radiating laser beams of different laser powers on the plural regions. Thereby, the label image can be printed by the laser beams of the optimal laser powers over the entire label surface.

The structure of the optical disk apparatus in the third embodiment is basically the same as that in the first embodiment, so a description of the circuit structure of the optical disk apparatus in the third embodiment is omitted here.

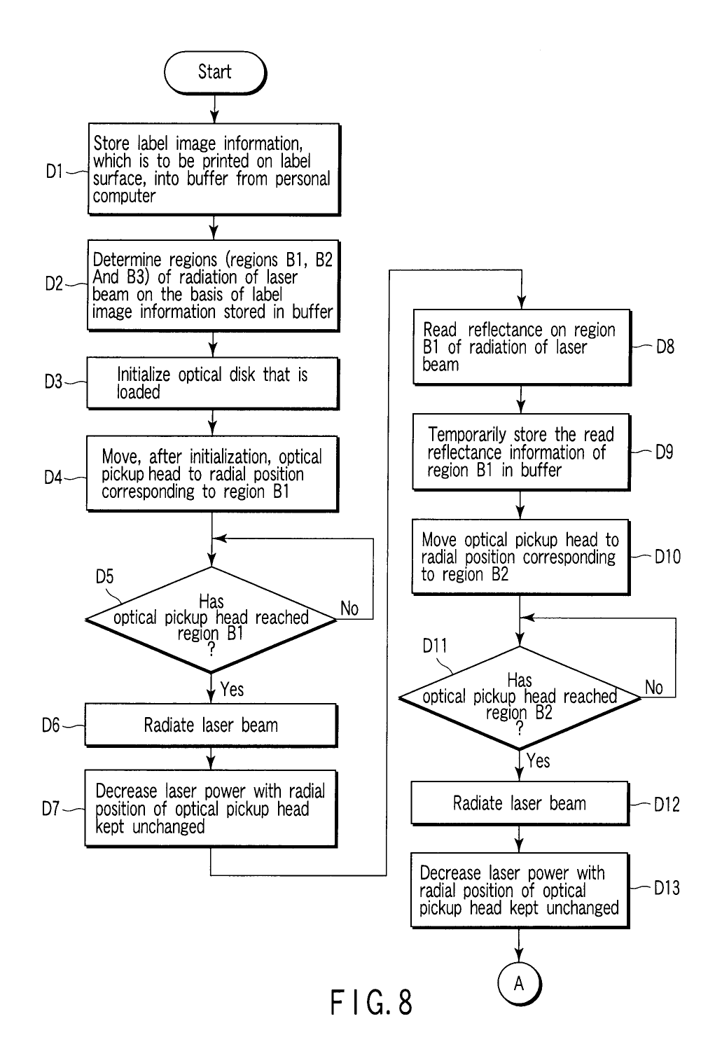

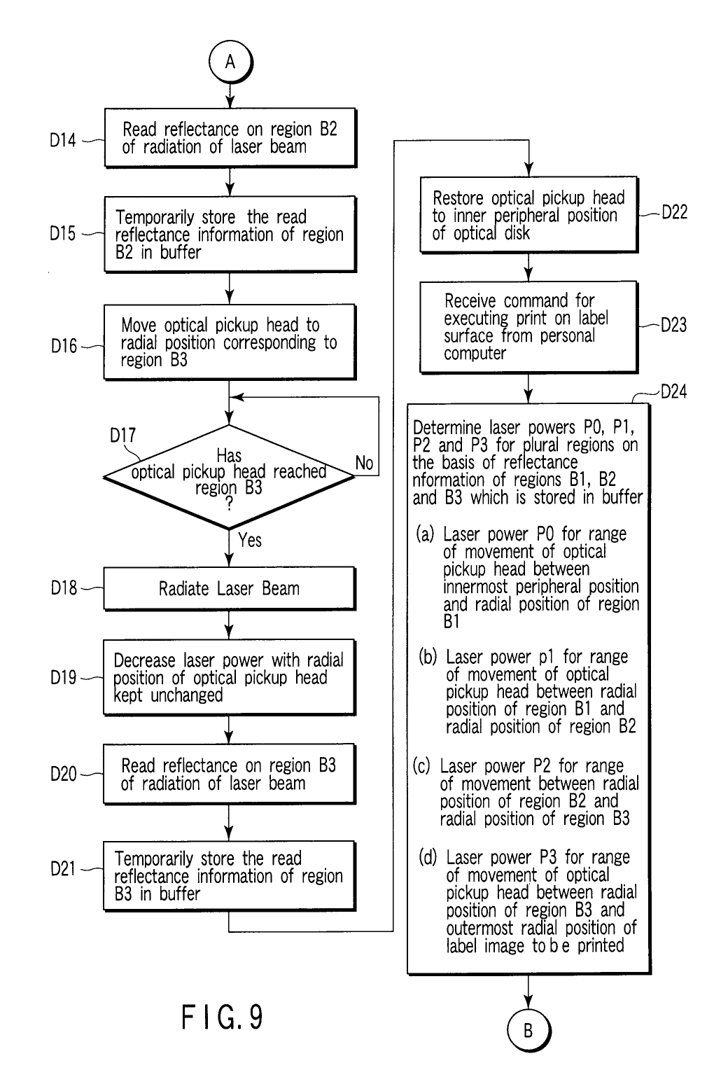

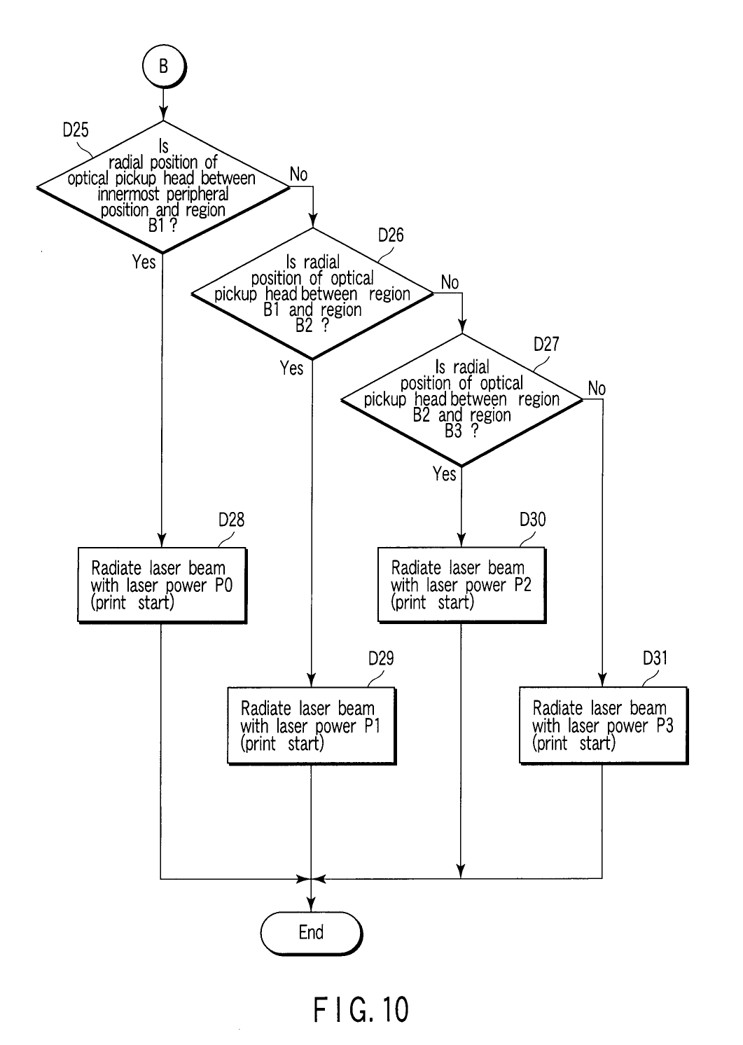

The operation of the optical disk apparatus according to the third embodiment is described with reference to flowcharts of FIG. 8, FIG. 9 and FIG. 10. As regards the third embodiment, too, a description is given of the case of printing on the label surface of the optical disk 1 with reference to FIG. 7.

The process of steps D1 to D23 in FIG. 8 and FIG. 9 are executed in the same manner as the process of steps C1 to C23 in the flowcharts of FIG. 5 and FIG. 6, so a description thereof is omitted here.

If the laser power setting unit 7c receives the print start command from the personal computer 11 via the external interface unit 7e (step D23), the laser power setting unit 7c determines optimal laser powers P0, P1, P2 and P3 for the printing on a plurality of regions on the label surface on the basis of the reflectance information relating to the measurement regions B1, B2 and B3, which is stored in the buffer memory 8. In addition, the laser power setting unit 7c sets parameters for causing the optical pickup head 4 to radiate laser beams of the optimal laser powers P0, P1, P2 and P3 (step D24).

The plural regions, which are divided in the radial direction of the label surface, comprise a 0th region defined between an innermost peripheral position and a radial position corresponding to the measurement region B1, a first region defined between the radial position corresponding to the measurement region B1 and a radial position corresponding to the measurement region B2, a second region defined between the radial position corresponding to the measurement region B2 and a radial position corresponding to the measurement region B3, and a third region defined between the radial position corresponding to the measurement region B3 and an outermost peripheral position of a label image to be printed on the label surface.

The laser power setting unit 7c determines different laser powers for the respective regions (the 0th to third regions), i.e. laser power P0 for the 0th region, laser power P1 for the first region, laser power P2 for the second region, and laser power P3 for the third region.

A description is given of an example of the process for determining the laser powers P0, P1, P2 and P3 for the respective regions, which is executed in the laser power setting unit 7c.

Coefficient data, which corresponds to the characteristics of the special coating on the label surface, and data indicative of a default laser power for the optical disk 1 are prestored in the drive controller 7 in association with individual manufacturer information (media ID) which is recorded on the optical disk 1. In the initializing process executed in step D3, the drive controller 7 reads the manufacturer information (media ID) pre-recorded on the optical disk 1, and determines the coefficient data and default laser power corresponding to the media ID.

Specifically, the default laser power corresponding to the media ID that is read out in the initializing process is used as the laser power P0.

The laser power P1 is determined on the basis of an arithmetic result of multiplication between the reflectance read from the measurement region B1 and the coefficient data corresponding to the media ID.

The laser power P2 is determined on the basis of an arithmetic result of multiplication between the reflectance read from the measurement region B2 and the coefficient data corresponding to the media ID.

The laser power P3 is determined on the basis of an arithmetic result of multiplication between the reflectance read from the measurement region B3 and the coefficient data corresponding to the media ID.

In the case where warp, for example, occurs on the optical disk 1, different reflectances are detected on the measurement regions B1, B2 and B3. Accordingly, as described above, different laser powers are determined on the basis of the reflectances detected from the measurement regions B1, B2 and B3.

Subsequently, the drive controller 7 causes the print control unit 7d to start the print process on the label surface of the optical disk 1. The print control unit 7d executes printing of the label image by causing the optical pickup head 4 to radiate laser beams on the basis of the label image information stored in the buffer memory 8.

At this time, if the radial position of the optical pickup head 4 is between the innermost peripheral position of the optical disk 1 and the measurement region B1 (Yes in step D25), the print control unit 7d controls the laser driving unit 9 so that the laser beam, which is radiated from the optical pickup head 4, may have the laser power P0 (step D28).

If the radial position of the optical pickup head 4 is between the measurement region B1 and the measurement region B2 (Yes in step D26), the print control unit 7d controls the laser driving unit 9 so that the laser beam, which is radiated from the optical pickup head 4, may have the laser power P1 (step D29).

If the radial position of the optical pickup head 4 is between the measurement region B2 and the measurement region B3 (Yes in step D27), the print control unit 7d controls the laser driving unit 9 so that the laser beam, which is radiated from the optical pickup head 4, may have the laser power P2 (step D30).

If the radial position of the optical pickup head 4 is between the measurement region B3 and the outermost peripheral position of the label image to be printed (No in step D27), the print control unit 7d controls the laser driving unit 9 so that the laser beam, which is radiated from the optical pickup head 4, may have the laser power P3 (step D31).

As has been described above, in addition to the advantageous effect in the first embodiment, the optical disk apparatus of the third embodiment has the advantage that the plural laser powers P0, P1, P2 and P3 are set on the basis of the plural measurement regions B1, B2 and B3, and laser beams of the different laser powers can be radiated on the plural regions (the 0th to third regions) which are divided by the measurement regions B1, B2 and B3. Therefore, even if there occurs warp of the optical disk 1 or non-uniformity in the coating, the label image can be printed by radiating the laser beams of the optimal laser powers on the respective regions.

In the second and third embodiments, three measurement regions are set. Alternatively, more than three measurement regions may be set. Although the measurement regions are set at different positions in the radial direction of the optical disk 1, the measurement regions may be set at different positions in the circumferential direction. Besides, the number of measurement regions, which are set on the label surface, may dynamically be varied in accordance with, e.g. the size of the label image to be printed on the label surface of the optical disk 1.

In the first to third embodiments, coefficient data, which corresponds to the characteristics of the special coating on the label surface, is prestored in the drive controller 7 in association with individual manufacturer information (media ID) which is recorded on the optical disk 1. Alternatively, this coefficient data may be updated, for example, through the personal computer 11. Thereby, even in the case where a new kind of optical disk having characteristics of the coating on the label surface, which are different from those of the conventional disk 1, is marketed, coefficient data corresponding to this new kind of optical disk may be stored in the drive controller 7 and thus the optimal laser power can be determined in the same manner as described above.

The process that has been described in connection with each of the above-described embodiments may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer, which is mounted in various apparatuses, reads the program that is stored in the recording medium or receives the program via the communication media. The operation of the apparatus is controlled by the program, thereby executing the above-described process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk apparatus which prints label image information on a label surface of an optical disk, comprising:
an optical pickup head which radiates a laser beam on the label surface of the optical disk, thereby printing the label image information;
a laser driving unit which sets a laser power of the laser beam which is radiated from the optical pickup head;
a memory which stores the label image information; and
a control unit which determines a label image, which is to be printed on the label surface, on the basis of the label image information, sets a trial write region within a label image region on the label surface, causes the optical pickup head to radiate the laser beam on the trial write region, sets the laser power of the laser driving unit in accordance with a reflectance obtained from reflective light of the laser beam, and prints the label image information on the label surface.

2. The optical disk apparatus according to claim 1, wherein the control unit finds the label image region, which is to be set on the label surface, on the basis of the label image information, and sets the trial write region within the found label image region.

3. An optical disk apparatus which prints label image information on a label surface of an optical disk, comprising:
an optical pickup head which radiates a laser beam on the label surface of the optical disk, thereby printing the label image information;
a laser driving unit which sets a laser power of the laser beam which is radiated from the optical pickup head;
a memory which stores the label image information; and
a control unit which determines a label image, which is to be printed on the label surface, on the basis of the label image information, sets a plurality of trial write regions within a label image region on the label surface, causes the optical pickup head to radiate the laser beam on the plurality of trial write regions, sets the laser power of the laser driving unit on the basis of a plurality of reflectances obtained from reflective light of the laser beam, and prints the label image information on the label surface.

4. The optical disk apparatus according to claim 3, wherein the plurality of trial write regions are set within the label image region that is to be set on the label surface, and are set at different positions in a radial direction of the label surface.

5. The optical disk apparatus according to claim 3, wherein the control unit sets the laser power of the laser driving unit on the basis of a mean reflectance of the plurality of reflectances.

6. An optical disk apparatus which prints label image information on a label surface of an optical disk, comprising:
an optical pickup head which radiates a laser beam on the label surface of the optical disk, thereby printing the label image information;
a laser driving unit which sets a laser power of the laser beam which is radiated from the optical pickup head;
a memory which stores the label image information; and
a control unit which determines a label image, which is to be printed on the label surface, on the basis of the label image information, sets a plurality of trial write regions within a label image region on the label surface, causes the optical pickup head to radiate the laser beam on the plurality of trial write regions, sets the laser power of the laser driving unit individually for each of radial regions including the plurality of trial write regions on the basis of a plurality of reflectances obtained from reflective light of the laser beam, and prints the label image information on the label surface.

7. A label printing method for printing label image information on a label surface of an optical disk by causing an optical pickup head to radiate a laser beam on the label surface, comprising:
determining a label image, which is to be printed on the label surface, on the basis of the label image information;
setting a trial write region within a label image region on the label surface;
causing the optical pickup head to radiate the laser beam on the trial write region;
calculating a reflectance from reflective light from the trial write region;
setting a laser power of the optical pickup head in accordance with reflectance; and
causing the optical pickup head to radiate the laser beam of the set laser power on the label surface, and printing the label image information on the label surface.

8. A label printing method according to claim 7, wherein a plurality of trial write regions is set within the label image region on the label surface; and
the laser power of the optical pickup head is set on the basis of a plurality of reflectances corresponding to the plurality of trial write regions.

9. A label printing method for printing label image information on a label surface of an optical disk by causing an optical pickup head to radiate a laser beam on the label surface, comprising:
determining a label image, which is to be printed on the label surface, on the basis of the label image information;
setting a plurality of trial write regions within a label image region on the label surface;
causing the optical pickup head to radiate the laser beam on the plurality of trial write regions;
calculating a plurality of reflectances from reflective light from the plurality of trial write regions;
setting a plurality of laser powers of the optical pickup head individually for each of radial regions including the plurality of trial write regions on the basis of the plurality of reflectances; and
causing the optical pickup head to radiate the laser beam with the plurality of laser powers, which are set individually for each of the radial regions of the label surface, onto the label surface, and printing the label image information on the label surface.
